(19) United States
(12) Patent Application Publication
(10) Pub. No.: US 2016/0075068 A1
(43) Pub. Date: Mar. 17, 2016

(54) INJECTION MOLDING DEVICE

(71) Applicant: KABUSHIKI KAISHA TOYOTA JIDOSHOKKI, Kariya-shi (JP)

(72) Inventors: Kazuyuki YAMAGUCHI, Kariya-shi (JP); Hiroki YOSHIKAWA, Kariya-shi (JP)

(73) Assignee: KABUSHIKI KAISHA TOYOTA JIDOSHOKKI, Kariya-shi (JP)

(21) Appl. No.: 14/839,373

(22) Filed: Aug. 28, 2015

(30) Foreign Application Priority Data
Sep. 11, 2014 (JP) 2014-185122

(51) Int. Cl. B29C 45/77

(52) U.S. Cl. CPC B29C 45/77

(57) ABSTRACT

An injection molding device includes an injection plunger for injecting a molding material into a mold and pressurizing the molding material. The injection molding device further includes an injection cylinder, an injection module performing injection and a pressure boost module assisting pressure boost. The injection cylinder includes an operation cylinder, a motor, and a screw and a nut converts rotation of the motor into linear movement via the ball screw. The pressure boost module includes a compressed hydraulic oil storage part, a motor, a screw rotated by the motor and a nut that converts the rotation of the motor into linear movement, a compression member that compresses the hydraulic oil stored in the compressed hydraulic oil storage part, and a valve that allows or stops flow of the hydraulic oil stored in the compressed hydraulic oil storage part into the injection cylinder.

### BACKGROUND OF THE INVENTION

The present invention relates to an injection device that injects to fill a molding material into a mold cavity and pressurizes the molding material.

An injection molding device is known in the art that makes a molded article by injecting a molding material into a mold cavity. Japanese Patent Application Publication No. 2014-597 discloses an injection molding device that uses an electric motor to drive an injection cylinder. The injection molding device includes an acceleration cylinder and a pressure boost cylinder that are connected parallel to each other for driving the injection cylinder, and the pistons of the acceleration cylinder and the pressure boost cylinder are synchronously driven by the electric driving device including a motor, a ball screw and a nut.

The injection molding device further includes a check valve and a flow control circuit between the bottom chamber of the injection cylinder and the bottom chamber of the acceleration cylinder, which enables the acceleration cylinder and the pressure boost cylinder to drive the injection cylinder at a high speed and also enables the pressure boost cylinder to drive the injection cylinder at a high pressure by use of a single motor. The use of an electric driving device to drive the injection cylinder makes possible precise speed and pressure control.

Generally, the injection molding device operates in two different phases, namely, a high-speed phase operation and a pressure boost phase operation. Specifically, in the initial stage of the injection molding operation, an injection plunger of the injection molding device is moved forward at relatively high speed for reducing the time of molding cycle. Then, the molding material in the mold cavity is further pressurized by the force of the forward movement of the injection plunger so as to prevent the molded article from sink mark. Japanese Patent Application Publication No. 2000-84654 discloses a die casting machine as an example of the injection molding device, in which an electric driving device is used to perform the pressure boost phase operation.

Referring to FIG. 6, numeral 80 generally designates the die casting machine of the above-cited Publication No. 2000-84654. The die casting machine 80 includes an electric injection servomotor 81 and a movement conversion mechanism 82 for converting the rotation of the servomotor 81 to linear movement of the plunger. Specifically, in the die casting machine 80, the rotation of the injection servomotor 81 is converted by the movement conversion mechanism 82 into linear movement of a plunger tip 83. Molten metal in the injection sleeve 84 is injected into a mold cavity 85.

The die casting machine 80 further includes an energy conversion mechanism 87 that is linked to the servomotor 81 via a clutch 86. The energy conversion mechanism 87 includes an accumulator 88, an energy converter 89 and a flow control valve (not shown) that is interposed between the accumulator 88 and the energy converter 89, and the driving force (or the rotational energy) of the servomotor 81 is accumulated in the accumulator 88.

The die casting machine 80 further includes a control mechanism 90 that controls the operation of the clutch 86 so that driving force of the injection servomotor 81 is connected to either the energy conversion mechanism 87 or the movement conversion mechanism 97.

In the production of a molded article by the die casting machine 80, the rotational energy of the servomotor 81 is accumulated as the pressure in the accumulator 88 via the energy conversion mechanism 87. Then, the rotational energy of the servomotor 81 is converted by the movement conversion mechanism 82 to the forward movement of the plunger tip 83, with the result that the plunger tip 83 injects molten metal into the mold cavity 85. The pressure boost phase operation takes place next. During the pressure boost phase operation, the pressure accumulated in the accumulator 88 is supplemented to the driving force of the injection servomotor 81 via the energy conversion mechanism 87.

In the electric die casting machine 80 of the above-cited Publication, the rotational energy of the injection servomotor 81 is accumulated previously in the accumulator 88 and then the rotational energy of the injection servomotor 81 causes the plunger tip 83 to move forward and the molten metal is charged into the mold cavity 85. As is apparent from the above, the injection servomotor 81 is used separately for the accumulation of pressure in the accumulator 88 and the charging of the metal material into the mold cavity 85, so that the die casting machine 80 is low in productivity.

The present invention, which has been made in the light of the above problems, is directed to providing an injection molding device that provides an increased productivity.

### SUMMARY OF THE INVENTION

In accordance with an aspect of the present invention, there is provided an injection molding device having an injection plunger for injecting and filling a molding material into a mold and pressurizing the molding material. The injection molding device includes an injection cylinder that causes the injection plunger to inject the molding material. The injection molding device further includes an injection module that supplying hydraulic oil to the injection cylinder to perform the injection and a pressure boost module supplying the hydraulic oil to the injection cylinder to assist the injection plunger in pressurizing the molding material. The injection cylinder includes an operation cylinder that supplies and drains the hydraulic oil to and from the injection cylinder, an operation motor, an operation ball screw that is rotated by the operation motor, and an operation ball screw nut that is connected to the operation cylinder and converts the rotation of the operation motor into linear movement via the operation ball screw. The pressure boost module includes a compressed hydraulic oil storage part that is connected to the injection cylinder, a pressure accumulator motor, a pressure accumulator screw that is rotated by the pressure accumulator motor, a pressure accumulator nut that converts rotation of the pressure accumulator motor into linear movement via the pressure accumulator screw, a compression member that is connected to the pressure accumulator nut and compresses the hydraulic oil stored in the compressed hydraulic oil storage part, a valve that allows or stops flow of the hydraulic oil stored in the compressed hydraulic oil storage part into the injection cylinder.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a schematic diagram showing an injection molding device according to an embodiment of the present invention;

FIG. 2 is a schematic diagram of the injection molding device of FIG. 1, showing a high speed phase operation and a pressure accumulation phase operation of the injection molding device;

FIG. 3 is a schematic diagram of an injection module, showing a pressure boost phase operation;

FIG. 4 is a schematic diagram of a pressure accumulation module, showing the pressure boost phase operation;

FIG. 5 is a chart showing an operation of an injection cylinder of the injection molding device of FIG. 1;

FIG. 6 is a schematic diagram showing a die casting machine according to the background art.

### DETAILED DESCRIPTION OF THE EMBODIMENTS

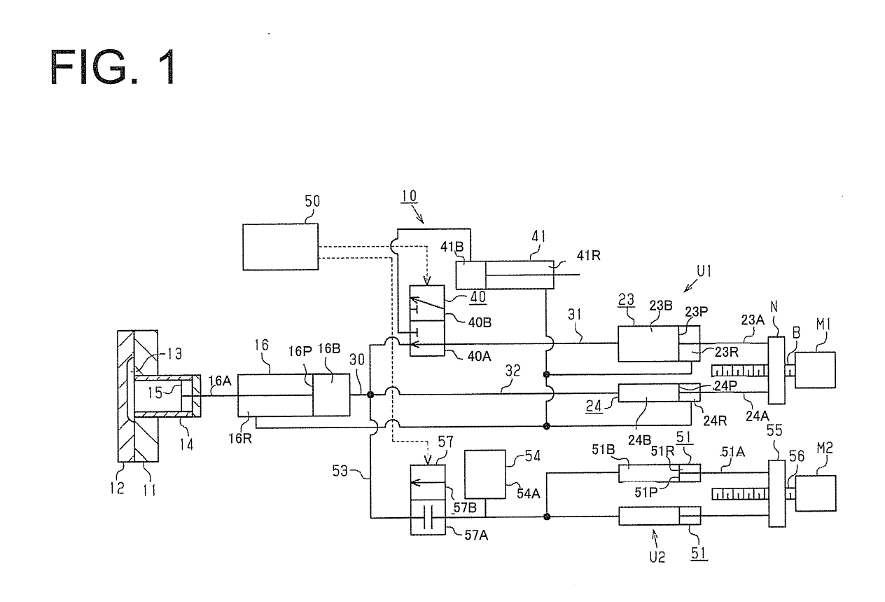

The following will describe a die casting machine as an example of the injection molding device according to an embodiment of the present invention with reference to FIGS. 1 through 5. Referring to FIG. 1, the die casting machine, which is designated by numeral 10, injects a molten metal (e.g. an aluminum alloy) as the molding material into a mold cavity 13 of a mold that is formed by a fixed mold member 11 and a movable mold member 12. A molded article is formed when the molding material is solidified in the mold cavity 13 and then removed therefrom. There is provided in the die casting machine a mold clamping device (not shown) that opens, closes and clamps the fixed mold member 11 and the movable mold member 12.

The die casting machine 10 includes an injection cylinder 16 having a piston rod 16A, and an injection plunger 15 is connected to the end of the piston rod 16A. The injection cylinder 16 drives the injection plunger 15. The injection plunger 15 driven by the injection cylinder 16 injects and fills the molten metal in an injection sleeve 14 into the mold cavity 13.

An operation cylinder 23 and a pressure boost cylinder 24 which supply and discharge hydraulic oil are connected to the injection cylinder 16 via tubes. Numeral 30 designates a main tube that is connected to a bottom chamber 16B of the injection cylinder 16 and serves as a supply and discharge passage of hydraulic oil and 31 and 32 designate a first sub-tube and a second sub-tube that are connected to the main-tube 30 and also serve as supply and discharge passages, respectively.

The first sub-tube 31 is connected to a bottom chamber 23B of the operation cylinder 23 that supplies and drains hydraulic oil to and from the bottom chamber 16B of the injection cylinder 16. The second sub-tube 32 is connected to a bottom chamber 24B of the pressure boost cylinder 24 that also supplies hydraulic oil to the bottom chamber 16B of the injection cylinder 16. The bottom chamber 23B of the operation cylinder 23 and the bottom chamber 24B of the pressure boost cylinder 24 are connected to the bottom chamber 16B of the injection cylinder 16 so that the operation cylinder and the pressure boost cylinder 24 are connected in parallel.

The operation cylinder 23 and the pressure boost cylinder 24 have rod chambers 23R and 24R, respectively, that are connected to a rod chamber 41R of a sub-tank 41 (which will be described later) and a rod chamber 16R of the injection cylinder 16.

The operation cylinder 23 and the pressure boost cylinder 24 have pistons 23P, 24P, respectively, whose stroke lengths are substantially the same. The pressure boost cylinder 24 has a diameter that is smaller than that of the operation cylinder 23.

The operation cylinder 23 has a piston rod 23A having at the end thereof the piston 23P and connected to an operation nut N. and the pressure boost cylinder 24 has a piston rod 24A having at the and thereof the piston 24P and connected to the operation nut N. An operation screw B, which is rotated by an operation servomotor Ml, is screwed through the operation nut N functions as an electric drive device. The operation nut N converts the rotation of the operation servomotor M1 into linear movement of the piston rods 23A, 24A via the operation screw B. The operation screw B and the operation nut N cooperate to form a ball screw mechanism. The operation nut N is configured to move in axial direction of the operation screw B with the rotation of the operation screw B.

With the linear movement of the operation nut N, the pistons 23P and 24P are movable in the operation cylinder 23 and the pressure boost cylinder 24, respectively. According to the embodiment of the present invention, the pistons 23P and 24P are so connected to the operation nut N so that the pistons 23P, 24P are movable simultaneously the same distance.

The die casting machine 10 has an injection module U1 including the operation cylinder 23, the pressure boost cylinder 24, the operation servomotor M1, the operation nut N and the operation screw B. The injection module U1 supplies hydraulic oil to the injection cylinder 16 to drive the injection plunger 15, thus forcing molten metal into the mold cavity 13.

In the injection module U1, the operations, or the positions, of the piston 23P of the operation cylinder 23 and the piston 24P of the pressure boost cylinder 24 are driven and controlled by the operation servomotor Ml, so that the supply of hydraulic oil to the injection cylinder 16 is precisely controlled.

A switch valve 40 is provided in the first sub-tube 31 connecting between the bottom chamber 23B of the operation cylinder 23 and the main-tube 30 that is connected to the bottom chamber 16B of the injection cylinder 16, and the switch valve 40 is connected to the sub-tank 41 via a tube.

The switch valve 40 may take a first position 40A that permits the flow of hydraulic oil from the bottom chamber 23B of the operation cylinder 23 to the bottom chamber 16B of the injection cylinder 16 and simultaneously prevents the backflow of hydraulic oil from the bottom chamber 41B of the sub-tank 41. The switch valve 40 may also take a second position 40B that permits the flow of hydraulic oil from the bottom chamber 23B of the operation cylinder 23 to the bottom chamber 41B of the sub-tank 41 and simultaneously prevents the backflow of hydraulic oil from the injection cylinder 16 and the pressure boost cylinder 24. In other words, the switch valve 40 functioning as a check valve is provided for stopping hydraulic oil in the bottom chamber 16B of the injection cylinder 16 from flowing into a bottom chamber 24B of the operation cylinder 24. The switch valve 40 is signally connected to a control device 50 that controls the switching operation of the switch valve 40 between the first position 40A and the second position 40B.

In the die casting machine 10, the main-tube 30 that is connected to the bottom chamber 16B of the injection cylinder 16 is also connected to a pressure boost tube 53 functioning as the passage of the hydraulic oil. The pressure boost tube 53 is connectable through a valve 57 to a pressure accumulator tank 54 that is formed as a storage chamber and has a case 54A in which compressed hydraulic oil may be stored. The die casting machine 10 has two pressure accumulator cylinders 51 each having a bottom chamber 51B to which the pressure accumulator tank 54 is connected via the pressure boost tube 53. The bottom chambers 51B of the two pressure accumulator cylinders 51 are disposed parallel to each other. The pressure accumulator cylinders 51 have substantially the same diameter and pistons 51 P of the respective cylinders 51 have substantially the same stroke length.

Each pressure accumulator cylinder 51 has a piston rod 51A having at one end thereof connected to the piston 51 P and the other end of the piston rod 51A to a pressure accumulator nut 55. A pressure accumulator screw 56 that is rotated by a pressure accumulator servomotor M2, that is, an electric driving device for the pressure accumulation, is screwed through the pressure accumulator nut 55. The pressure accumulator nut 55 converts the rotation of the pressure accumulator servomotor M2 into linear movement of the piston rod 51A via the pressure accumulator nut 55. That is, the pressure accumulator screw 56 and the pressure accumulator nut 55 cooperate to form the ball screw mechanism which is so configured that the pressure accumulator nut 55 is moved in axial direction of the pressure accumulator screw 56 with the rotation of the pressure accumulator screw 56.

A valve 57 is provided in the pressure boost tube 53 connecting the bottom chamber 16B of the injection cylinder 16 and the pressure accumulator tank 54. The valve 57 has two positions, namely a first position 57A in which the flow of hydraulic oil from the pressure accumulator tank 54 to the bottom chamber 16B of the injection cylinder 16 is prevented and a second position 57B in which the hydraulic oil is allowed to flow from the pressure accumulator tank 54 to the bottom chamber 16B of the injection cylinder 16. The valve 57 is signally connected to the control device 50 that controls the switching operation of the valve 57 between the first position 57A and the second position 57B. In other words, the valve 57 allows or stops flow of the hydraulic oil stored in the compressed hydraulic oil storage part into the injection cylinder 16.

The die casting machine 10 of the present embodiment has a pressure boost module U2 including the two pressure accumulator cylinders 51, the pressure accumulator servomotor M2, the pressure accumulator nut 55, the pressure accumulator screw 56, the pressure accumulator tank 54 and the valve 57. The pressure boost module U2 supplies hydraulic oil to the injection cylinder 16 to assist the injection plunger 15 in pressurizing the molding material.

In the pressure boost module U2, the pressure accumulator tank 54 as the storage chamber and the bottom chambers 51B of the pressure accumulator cylinder 51 are connected to the injection cylinder 16 and cooperate to form a compressed oil storage part into which the pressure accumulator cylinder 51 fills the hydraulic oil. In addition, the pistons 51P of the pressure accumulator cylinders 51 decrease the volume of the bottom chamber 51B of the pressure accumulator cylinder 51 thereby to compress the hydraulic oil stored in the pressure accumulator tank 54. The pistons 51P of the pressure accumulator cylinders 51 serve as the compression member of the present invention.

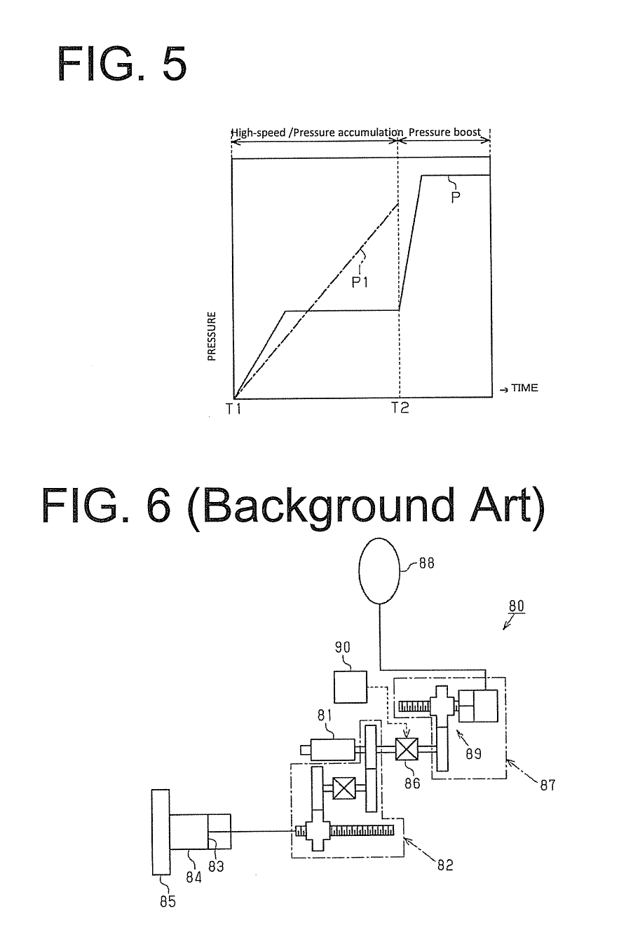

The following will describe the operation of the injection cylinder 16 with reference to FIG. 5. The die casting machine 10 is operable in two different phases, namely high-speed phase operation and the pressure boost phase operation. The initial operation of the die casting machine 10 is performed in the high-speed phase operation. Specifically, in the high-speed phase operation, the piston 16P of the injection cylinder 16 is moved at high speed to force molten metal in the injection sleeve 14 into the mold cavity 13. During the high-speed phase operation, the injection pressure P being applied to the molten metal is increased gradually to a predetermined pressure. The pressure boost phase operation, which takes place after the high-speed phase operation, is the last step of the injection molding process during which the molten metal in the mold cavity 13 is pressurized further by the forward movement of the piston 16P in the injection cylinder 16. The injection pressure P applied to the molten metal in the injection sleeve 14 during the pressure boost phase operation is greater than the injection pressure P during the high-speed phase operation.

In the die casting machine 10 of the embodiment of the present invention, pressure accumulation phase operation takes place for the pressure accumulator tank 54 simultaneously with the high speed phase operation. In the pressure accumulation phase operation, pressure is accumulated in the pressure accumulator tank 54 so as to assist the forward movement of the piston 16P in the injection cylinder 16 in the pressure boost phase operation. During the pressure accumulation phase operation, as shown by a dot-and-dash line in FIG. 5, the pressure P1 accumulated in the pressure accumulator tank 54 is gradually increased. During the subsequent pressure boost phase operation, hydraulic oil is supplied from the pressure boost module U2 to boost the pressure.

As shown in FIG. 5, the injection cylinder 16 needs to provide the injection pressure P that is suitable for each phase operation. Specifically, the injection pressure P that is needed to be provided by the piston 16P of the injection cylinder 16 in the pressure boost phase operation is greater than that of the pressure accumulation phase. Furthermore, the pressure boost module U2 accumulates the pressure in the pressure accumulation phase operation, so that the piston 16P of the injection cylinder 16 provides the desired injection pressure P in the pressure boost phase operation.

The following will describe the operation of the die casting machine 10 of the embodiment of the present invention with reference to FIGS. 1 to 5, beginning with the operation in the high-speed phase.

Before the high-speed phase operation, the piston 16P of the injection cylinder 16, the piston 23P of the operation cylinder and the piston 24P of the pressure boost cylinder 24 are in their initial positions as shown in FIG. 1. In such positions of the pistons 16P, 23P and 24P, no injection pressure P is applied to the molten metal in the injection sleeve 14 as indicated by T1 in FIG. 5. In addition, the switch valve 40 is in the first position 40A and the valve 57 is in the first position 57A, respectively.

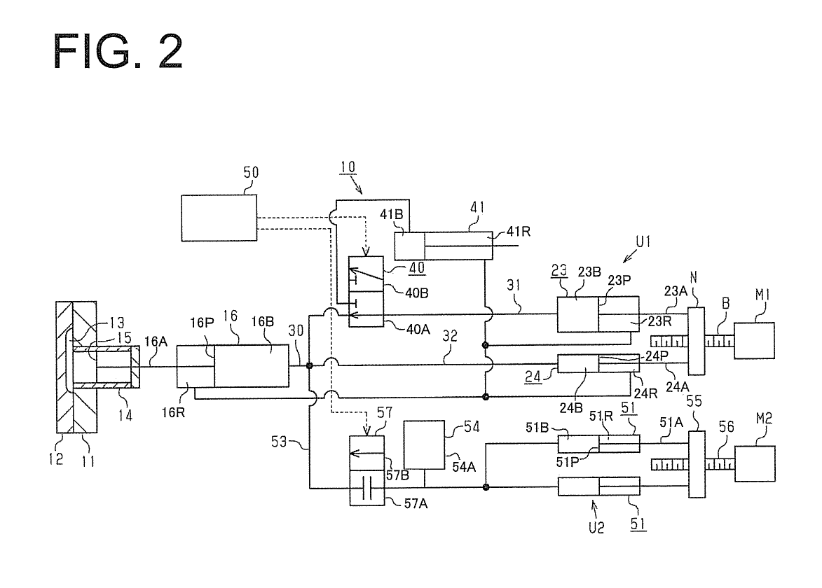

The high-speed phase operation starts when the fixed mold member 11 and the movable mold member 12 have been clamped and molten metal has been fed into the injection sleeve 14. With the rotation of the operation servomotor M1. the operation nut N makes a forward movement (leftward movement in FIG. 2). Consequently, the operation nut N causes the pistons 23P, 24P of the operation cylinder 23 and the pressure boost cylinder 24, respectively, to make a forward movement. The forward movement of the operation nut N and pistons 23P, 24P forces hydraulic oil in the bottom chambers 23B, 24B of the operation cylinder 23 and the pressure boost cylinder 24 into the bottom chamber 16B of the injection cylinder 16 through the main-tube 30.

The forward movement of the piston 23P of the operation cylinder 23 causes hydraulic oil in the bottom chamber 23B to flow through the first sub-tube 31, the switch valve 40 then placed in the first position 40A, the main-tube 30 and supplied into the bottom chamber 16B of the injection cylinder 16. Simultaneously, the forward movement of the piston 24P of the pressure boost cylinder 24 causes hydraulic oil in the bottom chamber 24B to flow through the second sub-tube 32 and the main-tube 30 and supplied into the bottom chamber 16B of the injection cylinder 16. As a result, the piston 16P of the injecting cylinder 16 is moved forward by the pressure of the hydraulic oil supplied into the bottom chamber 16B.

The piston 16P of the injection cylinder 16 makes the forward movement at a high-speed by the hydraulic oil that is supplied to the bottom chamber 16B from the operation cylinder 23 and the pressure boost cylinder 24. Thus, the injection plunger 15 connected to the piston rod 16A of the injection cylinder 16 make the forward movement at high-speed, which causes the molten metal in the injection sleeve 14 to be injected into the mold cavity 13 rapidly. The forward movements of the injection plunger 15 and the piston 16P forces the molten metal in the injection sleeve 14 into the mold cavity 13. During the high-speed phase operation, the injection pressure P is gradually increased to a predetermined level.

During the high-speed phase operation of the die casting machine 10, the pressure boost module U2 performs the pressure accumulation phase operation during which the hydraulic oil is compressed and accumulated in the pressure accumulator tank 54. FIG. 1 shows a state in which the pistons 51P of the pressure accumulator cylinders 51 are in the initial position before the pressure accumulation phase operation. The valve 57 is then in the first position 57A and hence closed.

When the pressure accumulation phase operation starts, the high speed phase operation is also started. When the pressure accumulator servomotor M2 is rotated in the pressure accumulation phase operation, the pressure accumulator nut 55 makes a forward movement (leftward movement in FIG. 2) by the rotation of the pressure accumulator servomotor M2. Thus, the piston 51P of the pressure accumulator cylinder 51 is driven to make the forward movement by the pressure accumulator nut 55. The forward movement of the pressure accumulator nut 55 and the piston 51P of the pressure accumulator cylinder 51 causes hydraulic oil in the bottom chambers 51B of the pressure accumulator cylinders 51 to flow into the pressure accumulator tank 54.

With the valve 57 closed, the total inside volume of the pressure accumulator tank 54 and the pressure accumulator cylinder 51 is decreased gradually with the forward movement of the pistons 51P of the pressure accumulator cylinders 51, which increases the pressure P1 in the pressure accumulator tank 54, as indicated by the dot-and-dash line in FIG. 5. As a result, the hydraulic oil is compressed and stored in the pressure accumulator tank 54 and the pressure accumulator cylinder 51. When the pressure P1 in the pressure accumulator tank 54 reaches the predetermined pressure, the pressure accumulation phase operation is completed and the pressure accumulator servomotor M2 is stopped.

In the high-speed phase operation, the injection cylinder 16 causes the injection plunger 15 to inject the molten metal at high-speed until the filling is completed at T2 in FIG. 5. Then, the switch valve 40 is switched and resistance is generated in the injection plunger 15 and the injection cylinder 16 against the forward movement of the piston 16P. The injection pressure P in the bottom chamber 16B of the injection cylinder 16 is increased by the hydraulic oil supplied from the operation cylinder 23 and the pressure boost cylinder 24.

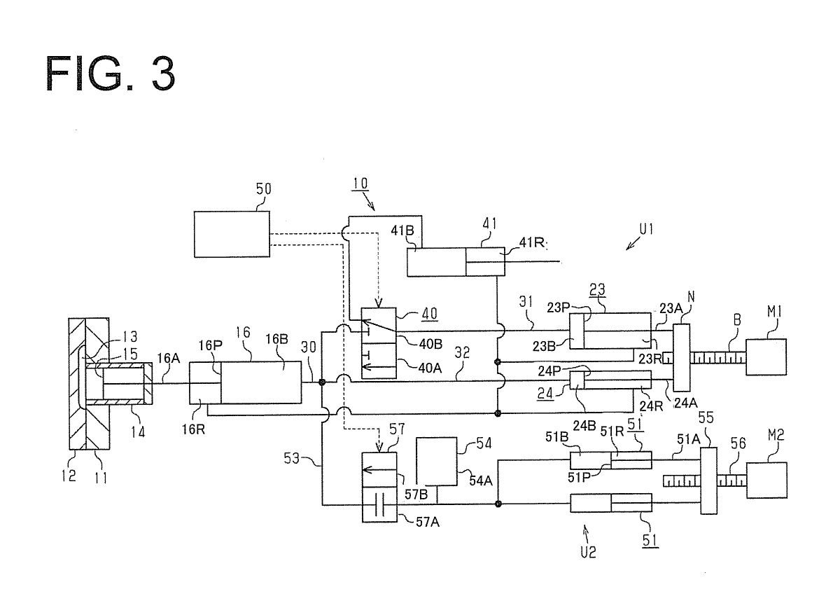

In the pressure boost phase operation, the pressure boost module U2 is controlled so that the injection pressure P becomes a desirable level as indicated in FIG. 5. As the switch valve 40 is switched to the second position 40B as shown in FIG. 3, a fluid communication is provided between the bottom chamber 23B of the operation cylinder 23 and the bottom chamber 41B of the sub-tank 41 and the communication between the bottom chamber 16B of the injection cylinder 16 and the bottom chamber 23B of the operation cylinder 23 is shut off.

In the pressure boost phase operation, the rotation of the operation servomotor M1 causes the operation nut N to make a forward movement and, accordingly, the pistons 23P, 24P of the operation cylinder 23 and the pressure boost cylinder 24 are moved forward.

The forward movement of the piston 23P of the operation cylinder 23 forces hydraulic oil in the bottom chamber 23B to flow through the first sub-tube 31 and the switch valve 40 in the second position 40B and to be discharged to the bottom chamber 41B of the sub-tank 41, but no hydraulic oil in the bottom chamber 23B of the operation cylinder 23 is then flowed into the bottom chamber 16B of the injection cylinder 16. Therefore, the rotation of the operation servomotor M1 does not work effective to feed hydraulic oil in the operation cylinder 23 into the injection cylinder 16.

On the other hand, the forward movement of the piston 24P of the pressure boost cylinder 24 causes hydraulic oil in the bottom chamber 24B to flow through the second sub-tube 32 and the main-tube 30 and to be supplied to the bottom chamber 16B of the injection cylinder 16. Thus, hydraulic oil is supplied to the bottom chamber 16B of the injection cylinder 16 only from the bottom chamber 24B of the pressure boost cylinder 24 to cause the injection plunger 17 to pressurize the molding material. As a result, the supply of hydraulic oil to the bottom chamber 16B of the injection cylinder 16 is decreased, as compared with the case in which hydraulic oil is supplied from both the bottom chambers 23B of the operation cylinder 23 and the bottom chamber 24B of the pressure boost cylinder 24. Thus, the rotation of the operation servomotor M1 works effective to feed hydraulic oil in the pressure boost cylinder 24 into the injection cylinder 16.

Because the pressure boost cylinder 24 has a diameter that is smaller than that of the operation cylinder 23, the pressure boost cylinder 24 generates a greater pressure than the operation cylinder 23 when the operation nut N is moved forward by the operation servomotor M1. When the hydraulic oil in the pressure boost cylinder 24 is supplied to the bottom chamber 16B of the injection cylinder 16, the pressure in the bottom chamber 16B is increased in accordance with Pascal's law and the pressure acting on the piston 16P of the injection cylinder 16 is also increased. As a result, the injection pressure P of the injection plunger 15 to pressurize the molten material in the mold cavity 13 is increased.

Furthermore, the switch valve 40 in the second position 40B functions as a check valve in that the hydraulic oil from the pressure boost cylinder 24 flows to the bottom chamber 16B of the injection cylinder 16 without entering into the bottom chamber 23B of the operation cylinder 23 via the first sub-tube 31. Therefore, the piston 23P of the operation cylinder 23 is free from the influence of high-pressure hydraulic oil from the pressure boost cylinder 24 and remains the current position without moving in either direction.

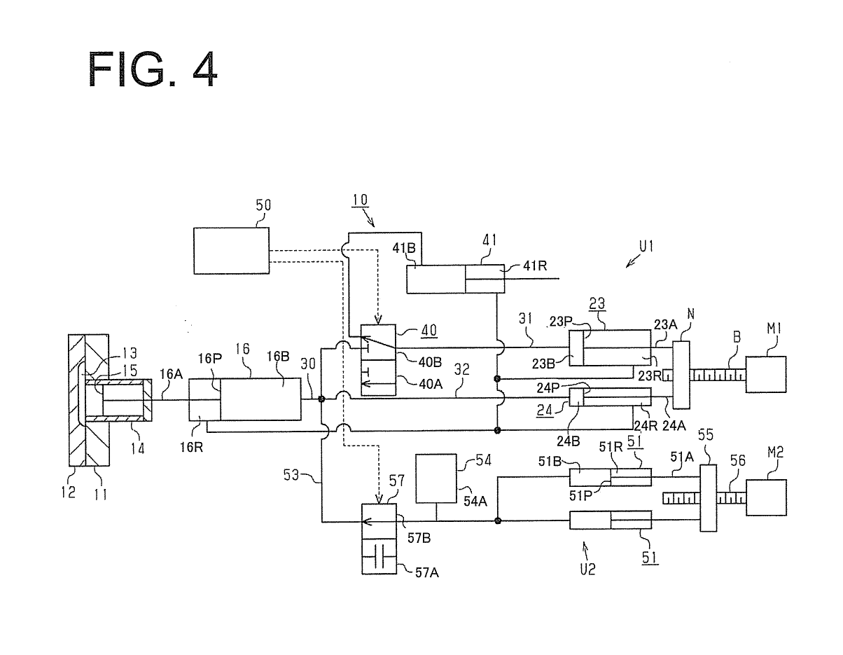

In the pressure boost phase operation, the valve 57 is switched to the second position 57B in response to a signal from the control device 50 and hence opened, as shown in FIG. 4, when the switch valve 40 is switched to the second position 40B. Accordingly, the pressure boost tube 53, which was closed by the valve 57, is opened, and the hydraulic oil stored in the pressure accumulator tank 54 and the pressure accumulator cylinder 51 is discharged to the pressure boost tube 53, through which the hydraulic oil is supplied to the bottom chamber 16B of the injection cylinder 16. Thus, in the pressure boost phase operation, the pressure in the bottom chamber 16B of the injection cylinder 16 is increased by the hydraulic oil that is flowed from the pressure boost cylinder 24 and the hydraulic oil that is supplied from the pressure boost module U2. As a result, the injection pressure P that is applied to the molten metal in the mold cavity 13 via the piston 16P of the injection cylinder 16 and the injection plunger 15 is increased to the desired pressure in a short time. In other words, during the pressure boost phase operation, the pressure boosting is accomplished by the pressure accumulated in the pressure boost module U2, as well as by the pressure developed by the pressure boost cylinder 24.

When the molten metal in the mold cavity 13 is solidified, the fixed mold member 11 and the movable mold member 12 are opened and a molded article is removed. The above-described embodiment offers the following effects.

(1) The die casting machine 10 includes the injection module U1 that supplies hydraulic oil to the injection cylinder 16 so as to causes the injection plunger 15 to perform the injection of molten metal into the mold cavity 13 and the pressure boost module U2 that supplies hydraulic oil to the injection cylinder so as to boost the pressure in the pressure boost phase operation. The pressure boost module U2 is driven by the pressure accumulator servomotor M2 that is different from the operation servomotor M1 of the injection module U1. The pressure is accumulated in the pressure accumulator tank 54 by the pressure accumulator servomotor M2 simultaneously with the supply of hydraulic oil supply by the injection module U1. Because the injection module U2 and the pressure boost module U2 are simultaneously operated, therefore, the time required for producing a molded article is reduced, thereby increasing productivity.
(2) In the die casting machine 10, the operation cylinder 23 and the pressure boost cylinder 24 of the injection module U1 are driven by the operation servomotor M1 and hence servo controlled. By thus controlling the operation cylinder 23 and the pressure boost cylinder 24, the flow of hydraulic oil from the operation cylinder 23 and the pressure boost cylinder 24 is controlled precisely, so that the injection cylinder 16 is operated appropriately. The injection cylinder 16 which is thus servo controlled is controlled more precisely as compared with a case in which the injection cylinder is hydraulically controlled.

Furthermore, the pressure accumulator cylinder 51 of the pressure boost module U2 is driven by the servomotor M2 and hence servo controlled. By thus controlling the operation of the pressure accumulator cylinder 51, the flow of hydraulic oil supplied from the pressure accumulator cylinders 51 and hence the pressure of the pressure accumulator tank 54 is precisely controlled. The pressure P1 for boosting the pressure in the pressure boost phase operation is controlled precisely, so that the pressure boost phase operation may be performed with the desired injection pressure P and, therefore, a molded article may be produced under the suitable conditions.

(3) During the pressure boost phase operation, the pressure is boosted by the pressure accumulated by the pressure boost module U2, as well as by the pressure from the pressure boost cylinder 24 of the injection module U1. Thus, the injection pressure P may reach the desired level in less time, as compared with the case in which the pressure boost phase operation is performed only by pressure boost cylinder 24.
(4) In the pressure boost module U2, the bottom chambers 51B of the pressure accumulator cylinders 51 and the pressure accumulator tank 54 cooperate to form the compressed hydraulic oil storage part. Compared with the case in which only the bottom chamber 51 B of the pressure accumulator cylinder 51 is used for storage of hydraulic oil for pressure boosting, the provision of the pressure accumulator tank 54 reduces the length of the pressure accumulator cylinders 51, which may downsize the die casting machine 10.
(5) The storage chamber is formed by the pressure accumulator tank 54 in which compressed hydraulic oil is accumulated. As for the storage chamber, an accumulator that accumulates pressure by the compression of internal gas may be used. However, the use of an accumulator that uses compressed gas to discharge the hydraulic oil requires an increased amount of hydraulic oil for the pressure accumulation. The use of the pressure accumulator tank 54 requires less amount of hydraulic oil for the pressure accumulation because the hydraulic oil has less compressibility than gas.
(6) In the pressure boost module U2, the valve 57 is provided in the pressure boost tube 53 connecting between the bottom chamber 16B of the injection cylinder 16 and the pressure accumulator tank 54. In accumulating the pressure in the pressure accumulator tank 54 by the pressure accumulator cylinder 51, the valve 57 is placed in the first position 57A to shut off the pressure boost tube 53, thus the pressure accumulation in the pressure accumulator tank 54 being accomplished effectively. In the pressure boost phase operation in which the valve 57 is placed in the second position 57B or opened, the injection pressure P is boosted rapidly by quickly releasing the pressure accumulated in the pressure boost module U2.
(7) The operation cylinder 23 and the pressure boost cylinder 24 of the injection module U1 have different diameters. Thus, the injection pressure P required for the injection molding is provided by the operation cylinder 23 and the pressure boost cylinder 24, which enables the injection cylinder 16 to be operated appropriately.
(8) The switch valve 40 functioning as a check valve is provided in the first sub-tube 31 connected to the operation cylinder 23. Thus, when the pressure boost cylinder 24 having a small diameter performs the pressure boost phase operation, the backflow of the hydraulic oil to the operation cylinder 23 having a large diameter may be prevented. This enables the pressure boost cylinder 24 having small diameter to supply hydraulic oil to the injection cylinder 16 reliably and the injection cylinder 16 to perform the pressure boost phase operation successfully.

The above-described embodiment of the present invention may be modified in various manners as exemplified below.

In the pressure boost module U2, the pressure accumulator tank 54 may be replaced by an accumulator in which pressure is accumulated by the compression of gas.

In the pressure boost module U2, the pressured hydraulic oil storage may be formed by the pressure accumulator cylinder 51 and the pressure boost tube 53 without the pressure accumulator tank 54. In such case, the volume of hydraulic oil required for the storage may be secured by increasing the length of the pressure boost cylinder 24 or the cross section of the pressure boost pipe.

Although the pressure boost cylinder 24 is provided in the injection module U1 according to the above-described embodiment, the pressure boost cylinder 24 may be provided in the pressure boost module U2 and the injection module U1 may include only the operation cylinder 23.

In the pressure boost module U2, the number of pressure accumulator cylinders 51 is not limited to two.

In the injection module U1, the number of the operation cylinder 23 and the pressure boost cylinder 24 are not limited to one.

The injection molding device is applicable to resin molding in which a resin is injected into the mold cavity 13 to form a resin molding.

The operation motor and the pressure accumulator motor may not be a servomotor, but a motor of any other suitable type may be used.

What is claimed is:

1. An injection molding device comprising:
an injection plunger injecting and filling a molding material into a mold and pressurizing the molding material;
an injection cylinder causing the injection plunger to inject the molding material;
an injection module supplying hydraulic oil to the injection cylinder to perform the injection; and
a pressure boost module supplying the hydraulic oil to the injection cylinder to assist the injection plunger in pressurizing the molding material,
wherein the injection module includes an operation cylinder that supplies and drains the hydraulic oil to and from the injection cylinder, an operation motor, an operation screw that is rotated by the operation motor, and an operation nut that is connected to the operation cylinder and converts the rotation of the operation motor into linear movement via the operation screw, and
wherein the pressure boost module includes a compressed hydraulic oil storage part that is connected to the injection cylinder, a pressure accumulator motor, a pressure accumulator screw that is rotated by the pressure accumulator motor, a pressure accumulator nut that converts rotation of the pressure accumulator motor into linear movement via the pressure accumulator screw, a compression member that is connected to the pressure accumulator nut and compresses the hydraulic oil stored in the compressed hydraulic oil storage part, a valve that allows or stops flow of the hydraulic oil stored in the compressed hydraulic oil storage part into the injection cylinder.

2. The injection molding device according to claim 1, wherein the compressed hydraulic oil storage part stores the hydraulic oil in a bottom chamber of a pressure accumulator cylinder and a storage chamber into which the pressure accumulator cylinder fills the hydraulic oil, pressure accumulator cylinder including a piston that serves as the compression member.

3. The injection molding device according to claim 2, wherein the storage chamber is formed in a pressure accumulator tank.

4. The injection molding device according to claim 1, wherein the injection module includes a pressure boost cylinder that causes the injection plunger to pressurize the molding material, wherein the pressure boost cylinder is driven by the operation motor via the operation screw and the operation nut and has a diameter smaller than a diameter of the operation cylinder.

5. The injection molding device according to claim 4, wherein the operation cylinder and the pressure boost cylinder are connected to a bottom chamber of the injection cylinder no that the operation cylinder and the pressure boost cylinder are connected in parallel, and a switch valve functioning as a check valve is provided for stopping the hydraulic oil in the bottom chamber of the injection cylinder from flowing into a bottom chamber of the operation cylinder.
